(19) United States
(12) Patent Application Publication
(10) Pub. No.: US 2018/0160500 A1
(43) Pub. Date: Jun. 7, 2018

(54) LIGHT EMITTING DIODE LIGHTING SYSTEM FOR COMMERCIAL AND RESIDENTIAL APPLICATIONS

(71) Applicant: Craig Keith Sherburne, Edmonton (CA)

(72) Inventor: Craig Keith Sherburne, Edmonton (CA)

(21) Appl. No.: 15/368,606

(22) Filed: Dec. 3, 2016

(51) Int. Cl. H05B 33/08

(52) U.S. Cl. CPC H05B 33/0857

(57) ABSTRACT

The present invention provides for a novel system LED lights provided in a linear array, receiving electrical power from at lease one power supply with the need to introduce electrical power in more than one location of the linear array of LED lights.

### FIELD OF THE INVENTION

The present invention pertains to the field of low-voltage lighting assemblies, and in particular low-voltage lighting assemblies comprised of Light Emitting Diode (LED) lights connected in series.

### BACKGROUND OF THE INVENTION

All of the publications, patents and patent applications cited within this application are herein incorporated by reference in their entirety to the same extent as if the disclosure of each individual publication, patent application or patent was specifically and individually indicated to be incorporated by reference in its entirety.

The inclusion of LED lights as decoration and illumination in commercial and residential applications is becoming more commonplace, as users seek a means to increase the aesthetics of their internal, or external environment, as well as providing increased illumination and lighting within a space, or surrounding a space.

Low-voltage LED lights are powered by a transformer or battery providing electrical power in the form of current (Amperage, or Amps) and potential (Voltage or Volts); which is then utilized by the LED to generate light of specific wavelengths; with multiples of LEDs in close proximity combining to produce various of colors. These LED lights are usually, individually, “red”, “green” and “blue”, the combination of which is then perceived as being a color of visible light spectrum.

Each LED provides resistance to the current passing through it, and when LED lights are placed in a linear array (that is, in serial connection), it results in a decrease of voltage to each subsequent LED in the linear array. As well, each LED in the linear array consumes current, with a subsequent reduction of current for each subsequent LED within the linear array. As LEDs are designed to receive and operate within a specific range of voltage and amperage, the serial connection of LEDs results in a decrease of both current and voltage outside the operating range. With more advanced LED lighting systems, there is a further electronic connection to an integrated circuit or computing element which controls the LED, which allows more complex triggering and independent control of each LED light.

The prior art describes the introduction of electrical power to serial connections of LED lights to ensure provision of voltage and amperage in accordance with operating range of the LED. Should there be an electronic connection between the LEDs, then the art describes the use of a continuous electronic connection between LEDs. Although the electronic connection between the integrated circuit or computing elements is usually a separate and distinct electrical circuit from that providing power to the LED; there is a concern that sequential addition of electrical power to a series of LEDs, particularly when large numbers of LEDs are added in serial to form a linear array, can lead to a large amount of Power (Volt*Amps, or Watts) passing through the electrical system forming part of the LED lighting system.

The art is in need of an improved means of creating linear arrays of LED lighting for commercial and residential applications.

### SUMMARY OF THE INVENTION

The present invention provides for a system for connecting low-voltage LED lumieres comprising a first multiplicity of low-voltage Light Emitting Diode (LED) lumieres, each LED lumiere comprising:
a first multiplicity of low-voltage Light Emitting Diode (LED) lumieres, each LED lumiere comprising at least one LED under the control of an LED lumiere control microprocessor,
   Said first multiplicity of low-voltage LED lumieres comprising a first LED lumiere, at least one successive intermediate LED lumiere and a last LED lumiere;
   Said first LED lumiere control microprocessor in digital communication with a preceding LED controller;
   Each at least one successive intermediate LED lumiere having its LED lumiere control microprocessor in digital communication with a preceding and succeeding LED lumiere control microprocessor;
Said control microprocessor of said first LED lumiere and said at least one successive intermediate LED lumiere control microprocessors receiving a digital signal, amplifying, and communicating at least a portion of said digital signal to a successive LED lumiere control microprocessor, thereby forming a control circuit; and
Wherein said first LED lumiere, said last LED lumiere and at least one intermediate successive LED lumieres are in digital communication by way of an electrical conductor;
A second multiplicity of low-voltage Light Emitting Diode (LED) lumiere, each LED lumiere comprising at least one LED under the control of a control microprocessor,
   Said second multiplicity of low-voltage LED lumieres comprising a first LED lumiere, at least one successive intermediate LED lumiere and a last LED lumiere;
   Each successive at least one intermediate LED lumiere having said control microprocessor in digital communication with a preceding and succeeding LED lumiere control microprocessor;
   Said first LED lumiere control microprocessor in digital communication with said last LED lumiere control microprocessor of the first multiplicity of LED lumieres;
   Said last LED lumiere being in digital communication with a preceding LED lumiere control microprocessor;
   Said first LED lumiere control microprocessor and said at least one successive intermediate LED lumieres receiving a digital signal, amplifying, and communicating at least a portion of said digital signal to a successive LED lumiere control microprocessor, thereby forming a control circuit; and
   Wherein said first LED lumiere, said last LED lumiere and at least one intermediate successive LED lumieres are in digital communication by way of an electrical conductor;
Wherein the first LED lumiere of said first multiplicity of LED lumieres receives power from a first power supply in electrical communication with said first LED lumiere of said first multiplicity of LED lumieres, by way of a conductor providing electrical communication between successive intermediate lumieres; and wherein;
   Said first LED lumieres, said successive intermediate LED lumieres and said last LED lumiere of said first multiplicity of LED lumieres are in electrical communication with said power supply; providing a first power circuit;
Wherein first LED lumiere of said second multiplicity of LED lumieres receives power from a second power supply in electrical communication with said first LED lumiere of said second multiplicity of LED lumieres by way of a conductor providing electrical communication between successive intermediate lumieres; and wherein;
   Said first LED lumiere, said successive intermediate LED lumieres and said last LED lumiere of said second multiplicity of LED lumieres are in electrical communication with said second power supply; providing a second power circuit;
      And wherein, interposed between, and in digital communication with, first multiplicity of LED lumieres and second multiplicity of LED lumieres is an electronic device, receiving a digital signal from the LED lumiere control microprocessor of the last LED lumiere of the first multiplicity of LED lumieres, amplifying said digital signal, and transmitting to the LED lumiere control microprocessor of the first LED lumiere of said second multiplicity of LED lumieres an amplified digital signal; and wherein said electronic device contains at least one diode preventing transfer of electrical power from said first LED lumiere of said second multiplicity of LED lumieres to the last lumiere of said first multiplicity of LED lumieres.

In one embodiment of the present invention the LED lumiere control microprocessor is a UCS1903 three-channel LED display driver/controller. In a further embodiment of the present invention the LED lumiere is comprised of a red, a green and a blue 5050 LED.

In another embodiment of the present invention the LED control microprocessor is a WS2811 three-channel LED display driver/controller. In a further embodiment of the present invention the LED lumiere is comprised of a red, a green and a blue 5050 LED.

In another embodiment of the present invention the LED lumiere is comprised of a red 5050 LED, a green 5050 LED and a blue 5050 LED.

### BRIEF DESCRIPTION OF THE FIGURES

FIG. 1 shows a schematic of the system of the present invention; and

FIG. 2 shows a representative illustration of a LED lumiere system of the present invention;

### DETAILED DESCRIPTION OF THE PRESENT INVENTION

As used herein “low-voltage” means provision of potential of less than 40 Volts as a power source for an LED light, more preferably of voltage equal to, or less than, 12 Volts.

As used herein, “lumiere” means a device intended to provide illumination.

As used herein “microprocessor” means an integrated circuit or other form of computing element, capable of receiving instructions by way of digital communication, executing said instructions, and altering the electronic state of disparate elements in electrical communication with said microprocessor.

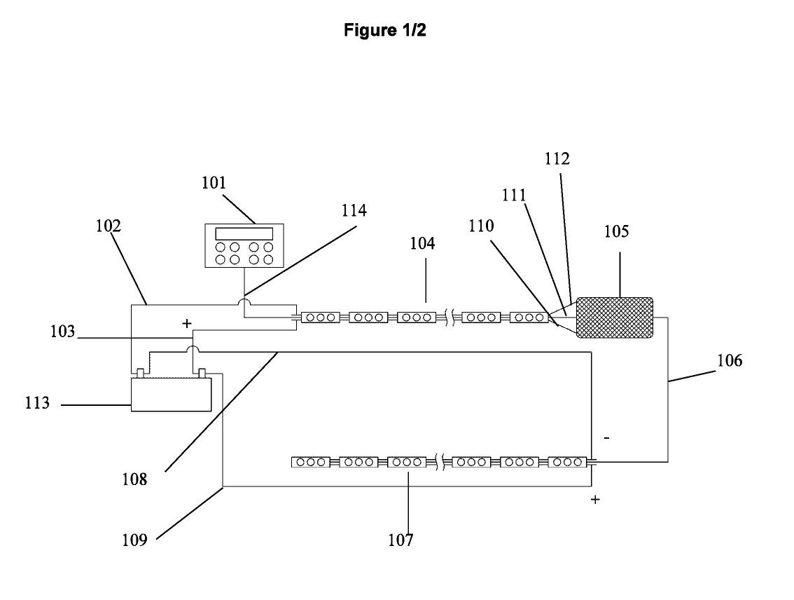

With reference to FIG. 1., there is represented an embodiment of the present invention.

FIG. 1 shows a schematic of one example of a LED lighting system, comprised of a direct current low-voltage power supply 113 with power (+) 103 and ground (−) 102; providing a combination of voltage and current to a first multiplicity of LED lumieres, commonly referred to as a “lighting string”, 104. A second lighting string, 107, exists some distance away from the first lighting string 104, in electronic communication through conductor 106, being by way of non-limiting example, a wire. Each of the LED lights in lighting string 104 and 105 is under the control of a LED lumiere control microprocessor (not shown) which is in digital communication with LED lighting controller 101 through conductor 114, being by way of non-limiting example, a metal wire.

Digital information provided by LED controller 101 is received by in the form of a digital electronic signal communicated along conductor 114 to the first LED lumiere control microprocessor within the first lighting string, a portion of the digital information is read and executed by the LED lumiere control microprocessor and a truncated portion of the digital information amplified and communicated to the next successive LED lumiere control microprocessor; usually truncated by removal of the digital information read and executed by the transmitting LED lumiere control microprocessor. The digital information contains instructional code for the turning on, or off, of the LED lights forming part of the LED lumiere under the control of the LED lumiere control microprocessor. By way of non-limiting example, should the LED lumiere be composed of red, green, and blue LEDs under the LED lumiere control microprocessor, then various transmissive colors may be generated for viewing by distant observers. This process is then repeated for each successive LED lumiere control microprocessor.

Should there be a need to continue the digital communication between successive LED lumieres, for example the last LED lumiere of the first lighting string 104 and the first LED lumiere of the second lighting string 107, then the digital electronic signal may be transmitted through conductor 106. The prior art has described the use of three separate conductors (not shown) communicating direct current power from the last LED lumiere of the first lighting string 104 to the first LED lumiere of the second lighting string 107. This results in the first lighting string 104 and the second lighting string 107 forming part of a single control circuit, as well as forming part of an electrical power circuit. For shorter lighting strings, particularly for low-voltage applications, common electrical power circuits through multiplicities of lighting strings is not problematic.

As lighting string lengths increase though, the total power passing within the common electrical power circuit can be large. For example, it is common to use individual direct current power supplies of less than 100 Watts of power in commercial and residential applications. If a lighting string, or multiplicity of lighting strings, is composed of 12 volt LED lumieres using 0.6 Amps of current at maximum brightness, then the power supply can provide power to under 138 LED lumieres. The prior art therefore describes introduction of additional power supply into the lighting strings, to provide the individual LED lumieres with appropriate current and voltage. As more LED lumieres are provided within the system, for example 400 or 680, the total power running through the common electrical power circuit for the LED lumieres can be as high as 300 or 500 Watts, respectively. Although each LED lumiere is individually receiving 12 Volts with a maximum of 8.33 Amps (for a 100 Watt power supply providing a constant 12 Volts), the lighting system has a total of 300 or 500 Watts, respectively, within the common electrical power circuit. As the total number of LED lumieres in the system increases to 3000 or 6000 LED lumieres, by way of example, the power within the common electrical power circuit can increase to levels outside of the normal operating range (3,000 to 6,000 Watts).

One way the prior art has used to address this issue is to establish separate power and control circuits for lighting strands, yet lighting strands using successive digital electronic communication are not suited to establishing of a second control circuit.

Further, for longer lengths of conductor, 106, used to provide digital electronic communication, there may be a degradation of the digital electronic signal which will interfere with the intended operation of the successive LED lumieres 107. Although dependent upon the form of control microprocessor providing the signal amplification, the ambient and operating temperature, and the performance characteristics of the conductor 106 chosen; there will be a length of conductor 106 which will result in attenuation of the digital electronic signal below the ability of the LED lumiere microcontroller to detect or accurately amplify and communicate a digital signal downstream to successive LED lumieres.

It is the novel addition of electronic device 105 within the lighting system that provides, for the first time, the establishing of common control circuit between successive lighting strands while allowing the establishment of a multiplicity of electrical power circuits, with the ability to limit the total power through any one electrical power circuit to a number chosen by the operator or lighting strand installer, such as, by way of non-limiting example, 100 Watts. Further, electronic device 105 may also provide amplification of the digital electronic communication, drawing power for such activities from the electrical power circuit provided for the first lighting strand, communicated through conductor 110 providing DC current, conductor 112 acting as a ground for the electrical circuit, conductor 111 providing the electronic digital communication and following conductor 106 providing the digital electronic communication for the amplified signal. Electronic device 105 contains a diode which allows for the flow of electrical current in only one direction, out of electronic device 105 and into conductor 106; thereby isolating subsequent lighting strand 107 from the power circuit of preceding lighting strand 104, while maintaining a common control circuit.

As shown in FIG. 1, electronic device 105 is interposed between the first and second lighting strand, and in the presented embodiment, device 105 also provides amplification of the digital electronic signal exiting from the last LED lumiere of the first lighting strand through conductor 111, also receiving power (112, 110) through electrical conductors; and then communicating said amplified digital electronic signal through conductor 106 to the second lighting strand. As presented in FIG. 1, the second lighting strand is energized from common DC power supply 113 by electrical conductors 109 providing power and 108 acting as ground, but it is contemplated that in other embodiments that conductors 108 and 109 would be in electrical communication with a different power supply than power supply 113 as illustrated.

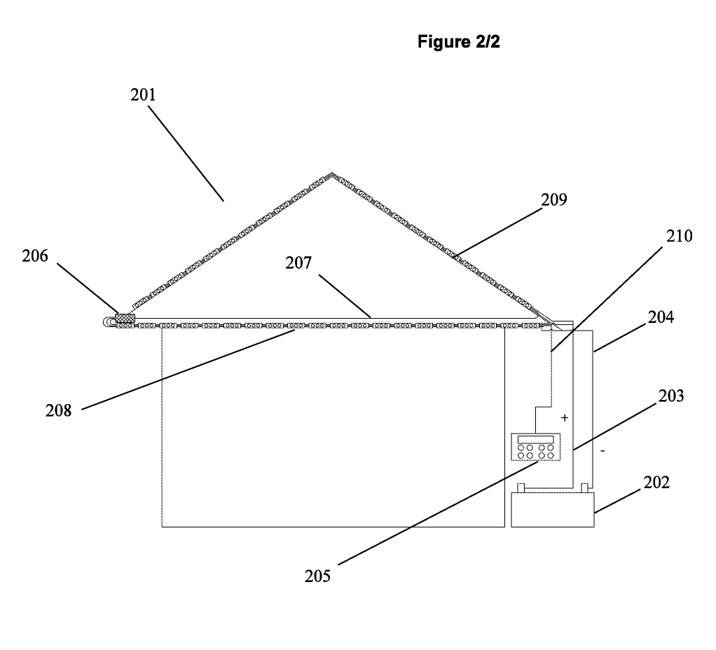

FIG. 2 provides an illustration of the lighting system of the present invention installed in residential home, 201, with DC power supply 202 providing power to first lighting strand 208 through conductors 203 (power, +) and 204 (ground, −) with digital electronic communication between LED controller 205 and first lighting strand 208 through conductor 210. Electronic device 206, comprising an amplifier, such as, by way of non-limiting example, the LT-122, two-channel Serial Peripheral Interface Signal Amplifier, with a diode function included in the output, preventing transmission of electrical current in the direction opposite to the flow of electronic digital information along conductor 207. Conductor 207 traverses the span of the first lighting strand 208, connecting to a second lighting strand 209, where power is introduced through conductors (not shown) leading to power supply 202, or alternatively to a separate power supply (not shown).

While particular embodiments of the present invention have been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiments. The invention is therefore to be considered limited solely by the scope of the appended claims.

What is claimed is:

1. A system for connecting low-voltage LED lumieres comprising:
a first multiplicity of low-voltage Light Emitting Diode (LED) lumieres, each LED lumiere comprising at least one LED under the control of an LED lumiere control microprocessor,
Said first multiplicity of low-voltage LED lumieres comprising a first LED lumiere, at least one successive intermediate LED lumiere and a last LED lumiere;
Said first LED lumiere control microprocessor in digital communication with a preceding LED controller;
Each at least one successive intermediate LED lumiere having its LED lumiere control microprocessor in digital communication with a preceding and succeeding LED lumiere control microprocessor;
Said control microprocessor of said first LED lumiere and said at least one successive intermediate LED lumiere control microprocessors receiving a digital signal, amplifying, and communicating at least a portion of said digital signal to a successive LED lumiere control microprocessor, thereby forming a control circuit; and
Wherein said first LED lumiere, said last LED lumiere and at least one intermediate successive LED lumieres are in digital communication by way of an electrical conductor;
A second multiplicity of low-voltage Light Emitting Diode (LED) lumiere, each LED lumiere comprising at least one LED under the control of a control microprocessor,
Said second multiplicity of low-voltage LED lumieres comprising a first LED lumiere, at least one successive intermediate LED lumiere and a last LED lumiere;
Each successive at least one intermediate LED lumiere having said control microprocessor in digital communication with a preceding and succeeding LED lumiere control microprocessor;
Said first LED lumiere control microprocessor in digital communication with said last LED lumiere control microprocessor of the first multiplicity of LED lumieres;
Said last LED lumiere being in digital communication with a preceding LED lumiere control microprocessor;
Said first LED lumiere control microprocessor and said at least one successive intermediate LED lumieres receiving a digital signal, amplifying, and communicating at least a portion of said digital signal to a successive LED lumiere control microprocessor, thereby forming a control circuit; and
Wherein said first LED lumiere, said last LED lumiere and at least one intermediate successive LED lumieres are in digital communication by way of an electrical conductor;
Wherein first LED lumiere of said first multiplicity of LED lumieres receives power from a first power supply in electrical communication with said first LED lumiere of said first multiplicity of LED lumieres by way of a conductor providing electrical communication between successive intermediate lumieres; and wherein;
Said first LED lumieres, said successive intermediate LED lumieres and said last LED lumiere of said first multiplicity of LED lumieres are in electrical communication with said power supply; providing a first power circuit;
Wherein first LED lumiere of said second multiplicity of LED lumieres receives power from a second power supply in electrical communication with said first LED lumiere of said second multiplicity of LED lumieres by way of a conductor providing electrical communication between successive intermediate lumieres; and wherein;
Said first LED lumiere, said successive intermediate LED lumieres and said last LED lumiere of said second multiplicity of LED lumieres are in electrical communication with said second power supply; providing a second power circuit;
And wherein, interposed between, and in digital communication with, first multiplicity of LED lumieres and second multiplicity of LED lumieres is an electronic device, receiving a digital signal from the LED lumiere control microprocessor of the last LED lumiere of the first multiplicity of LED lumieres, amplifying said digital signal, and transmitting to the LED lumiere control microprocessor of the first LED lumiere of said second multiplicity of LED lumieres an amplified digital signal; and wherein said electronic device contains at least one diode preventing transfer of electrical power from said first LED lumiere of said second multiplicity of LED lumieres to the last lumiere of said first multiplicity of LED lumieres

2. The system of claim 1 wherein the control microprocessor is a UCS1903 three-channel LED display driver/controller.

3. The system of claim 2 wherein the LED lumiere is comprised of a red 5050 LED, a green 5050 LED and a blue 5050 LED.

4. The system of claim 1 wherein the control microprocessor is a WS2811 three-channel LED driver/controller.

5. The system of claim 4 wherein the LED lumiere is comprised of a red 5050 LED, a green 5050 LED and a blue 5050 LED.

6. The system of claim 1 wherein the LED lumiere is comprised of a red 5050 LED, a green 5050 LED and a blue 5050 LED.
